(19) United States
(12) Patent Application Publication
(10) Pub. No.: US 2026/0064840 A1
(43) Pub. Date: Mar. 5, 2026

(54) REPOSITORY SCANNING COORDINATOR

(71) Applicant: CrowdStrike, Inc., Sunnyvale, CA (US)

(72) Inventors: Ross Clarke, West Henrietta, NY (US); Julianna Madden, San Diego, CA (US); Zachary Panter, North Logan, UT (US); Kellen Arb, Austin, TX (US)

(21) Appl. No.: 18/818,433

(22) Filed: Aug. 28, 2024

(51) Int. Cl. G06F 21/56

(52) U.S. Cl. CPC G06F 21/563; G06F 2221/033

(57) ABSTRACT

A repository scanning coordinator is disclosed herein. The repository scanning coordinator manages parallel scanning of multiple source code repositories by multiple scanners, while also avoiding conflicts by preventing simultaneous scanning of any one single source code repository by more than one scanner at a time.

### BACKGROUND

With the increased focus on code supply chain security, companies increasingly purchase off the shelf source code scanning tools. These tools often operate independently. Unfortunately, the use of multiple uncoordinated independent scanners slows down code scanning operations overall.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network environment comprising a scanning framework equipped with a repository scanning coordinator, in accordance with an embodiment of the present disclosure.

FIG. 2 illustrates an example repository scanning coordinator, scanners equipped to use the repository scanning coordinator, and a filesystem comprising source code repositories to be scanned by the scanners, in accordance with an embodiment of the present disclosure.

FIG. 3 illustrates an example repository scanning coordinator implementation and operations thereof, in accordance with an embodiment of the present disclosure.

FIG. 4 illustrates an example layout of a librarian application programming interface (API), in accordance with an embodiment of the present disclosure.

FIG. 5 illustrates example internal workflows and data structures used by a librarian API, in accordance with an embodiment of the present disclosure.

FIG. 6 illustrates example methods performed by a repository scanning coordinator, including a setup stage and a coordinate scans stage, in accordance with an embodiment of the present disclosure.

FIG. 7 illustrates an example system equipped to perform the techniques described herein, in accordance with an embodiment of the present disclosure.

### DETAILED DESCRIPTION

A repository scanning coordinator is disclosed herein. The repository scanning coordinator manages parallel scanning of multiple source code repositories by multiple scanners, while also avoiding conflicts by preventing simultaneous scanning of any one single source code repository by more than one scanner at a time. The repository scanning coordinator can also provide various other useful features and functions described herein.

An example repository scanning coordinator implementation can include a library application programming interface (API) with access to a list or inventory of source code repositories to be scanned. Any desired scanners can be modified to interact with the library API. The modified scanners can each use the library API to identify their next source code repositories to be scanned.

In response to an API request from a scanner, the library API can be configured to identify a next source code repository for the scanner. The scanner can then proceed with scanning the identified next source code repository. The source code repository may be stored in a filesystem, and the scanner can access the filesystem to scan the identified next source code repository. After scanning, the scanner can return to the library API for an identification of yet another next source code repository. The scanner can repeat this repository identification and scanning process until all applicable repositories are scanned.

The library API can be configured to track the source code repositories previously scanned by each scanner, for example by storing log data. The library API can continue identifying next source code repositories for a scanner until all applicable source code repositories have been scanned by the scanner. In circumstances wherein a scanner need not scan all source code repositories, tags can be associated with the scanner to inform the library API of the applicable source code repositories which will (or will not) be scanned by the scanner.

Furthermore, in order to prevent simultaneous scanning of any one single source code repository by more than one scanner at a time, the library API can maintain availability status information for each source code repository. The availability status information can indicate whether the source code repository is available for scanning, or conversely, unavailable for scanning. The source code repository can be available for scanning when it is not currently being scanned by another scanner, and conversely the source code repository can be unavailable for scanning when it is currently being scanned by another scanner.

In an example, the library API can maintain availability status information for a source code repository by “checking out” the source code repository while the source code repository is being scanned by a scanner, and “checking in” the source code repository when the scanner has completed its scan. The library API can be configured to check out the source code repository, i.e., indicate the source code repository is unavailable, when the source code repository has been identified to a scanner as the scanner's next source code repository. When the scanner completes its scan of the source code repository and returns to the library API for an identification of another source code repository, the library API can be configured to check in the source code repository, i.e., indicate the source code repository is again available for scanning by any other scanners.

In order to initiate operations of the disclosed library API, one or more codebases can initially be enumerated in order to build the list or inventory of source code repositories used by the library API. Next, the source code repositories can optionally be retrieved and stored in a filesystem for efficient access by the scanners. Global information tracker (GIT) interactions can optionally be used to fetch the source code repositories from a source code manager, and the fetched source code repositories can be stored in the filesystem.

Source code repositories may have multiple associated branches or versions thereof, and the library API can be configured to also coordinate scanning of repository branches. In an example, as part of scanning a source code repository, a scanner may submit repository branch scan requests to the library API. In response to each repository branch scan request, the library API can be configured to retrieve a repository branch from an applicable source code manager, store the repository branch in the filesystem, and identify the repository branch to the scanner. The scanner can be configured to scan the identified repository branch, and then submit a next repository branch scan request to the library API. The library API can continue retrieving, storing, and identifying next repository branches to the scanner until all repository branches are scanned.

In order to further speed the scanning of source code repositories by scanners, embodiments can be adapted to run multiple instances of a same scanner. The multiple instances can be run as separate scanners which can scan different repositories in parallel, under coordination of the library API. However, the library API can log scans performed by the different instances of the same scanner as operations of the same scanner or same scanner type, so that the different instances need not re-scan source code repositories that were previously scanned by other instances of the same scanner type.

Some examples can also provide a scanner registration process whereby scanners can register themselves with the library API. A new scanner, which was not previously registered with the library API, can submit a scanner registration request to the library API, and the library API can receive the registration request. The registration request comprises a request to register the new scanner among multiple scanners which are registered with the library API. The library API can register the new scanner in response to the registration request. The library API can for example issue the new scanner a scanner identification number. The library API can also perform any desired security checks to ensure the new scanner is trusted to scan sensitive source code repositories.

Current source code management solutions provide access to remote source code but have no way to coordinate parallel scanners to ensure each scanner type scans the complete code base, while also preventing redundant scans. In contrast, the repository scanning coordinator disclosed herein enables multiple scanners to run in parallel against a remote code base.

The repository scanning coordinator can be configured to handle all remote interactions, building a local “inventory” of source code repositories that can be checked out by scanners in parallel. This enables a potentially large number of scanners to run in parallel, drastically reducing overall scanning time. Additionally, implementations can use tracking features to determine when discrete scanner types have completed scanning the entire code base, enabling multiple instances of a same scanner type to be run in parallel, further increasing scanner speeds.

Furthermore, embodiments can ensure only one scanner is scanning a specific repository at a time, ensuring no collisions occur between scanners. As a result, dynamic scanners and a broad range of applications beyond simple code scanners can also be coordinated by the disclosed repository scanning coordinator. Any tool that requires source code access can leverage the disclosed repository scanning coordinator to increase speed and offload computationally expensive overhead in remote codebase synching.

Some examples can leverage GIT to interface with remote code bases (e.g., source code manager or supply chain manager tools) such as BitBucket or GitHub. Embodiments can allow users to add remote repositories to a repository scanning coordinator's inventory using, e.g., a simple hypertext transfer protocol (HTTP) “post” request. Once a remote repository is retrieved and saved, or “cloned”, into a local inventory, scanners can request access via a checkout process, which can be implemented as an HTTP “get” request.

The disclosed processes can ensure proper metadata is stored about each scanner, and can then recursively find, for each scanner, next available repositories for scanning. A local copy of a source code repository can be loaned to a scanner for scanning. When the scanner finishes scanning the code, it can request to check out a next repository. By tracking scanner metadata internally and holding access via an “inventory”, the disclosed techniques can allow for strict access controls to be implemented and can consolidate remote access to only a single entity rather than giving each individual scanner access to the remote repositories. This not only creates a more performant solution for code scanning in mass, but also allows for stricter access controls, protecting organizations' intellectual property.

Some example implementations can offer complete functionality for managing and coordinating parallelized source code scanners. For example, implementations can be configured to interface with any source code manager. As long as the remote code storage solution leverages GIT, the repository scanning coordinator can integrate with it.

Furthermore, implementations can store logs or scanning histories which track which repositories have been scanned by which type of scanner. This ensures all applicable repositories are scanned by all scanner types, providing complete code base visibility.

Furthermore, implementations can enable source code localization, e.g., by handling all GIT interactions with remote source code managers, thereby allowing scanners to limit their interactions to local interactions with locally stored source code repositories. This reduces the risk surface by removing the need to provide access to remote code repositories to each individual scanner.

Furthermore, implementations can make use of repository access locks to ensure no collisions occur by multiple scanners attempting to scan a same source code repository at a same time. Implementations can provide an efficient mechanism to ensure proper parallel scans occur and no scanner is left waiting for access to a new repository.

Furthermore, implementations can include filtering and exclusion features. Rather than having to enforce an exclusion list at the scanner level, the repository scanning coordinator can centralize filtering and exclusion processing through the use of tags, which lowers the overall footprint for scope changes.

Furthermore, implementations can dramatically reduce network usage, which decreases network loads when performing remote code scanning. By having a centralized service such as the repository scanning coordinator handle interactions with source code managers, just one network call is needed to clone remote source code to a local filesystem, rather than many network calls per scanner.

The repository scanning coordinator can use the features disclosed herein to speed the operation of multiple scanners while also generating auditable scan trails which prove a code base was properly scanned. The repository scanning coordinator can coordinate an organization's internally developed scanners and off the shelf type scanners. The repository scanning coordinator can generally operate in a same space as supply chain security tooling, however, its functions can extend beyond that space as well. For example, the time to run integrated tools which scan for secrets can be reduced from days to hours. Other tools that require source code visibility can also be coordinated for increased speed and lower overhead.

Additionally, while this disclosure generally contemplates the use of a shared filesystem which can be implemented, e.g., as a Kubernetes type filesystem, some implementations can be generalized to not necessarily rely on a shared filesystem. A repository scanning coordinator can be used in conjunction with distributed scanners, each with its own filesystem, and the repository scanning coordinator can nonetheless achieve efficiency gains and ant-collision properties. A repository scanning coordinator can parallelize scanning operations thereby decreasing runtime but can optionally pass some GIT overhead onto individual scanners, resulting in somewhat lower but nonetheless meaningful GIT performance improvements.

Example implementations are provided below with reference to the following figures.

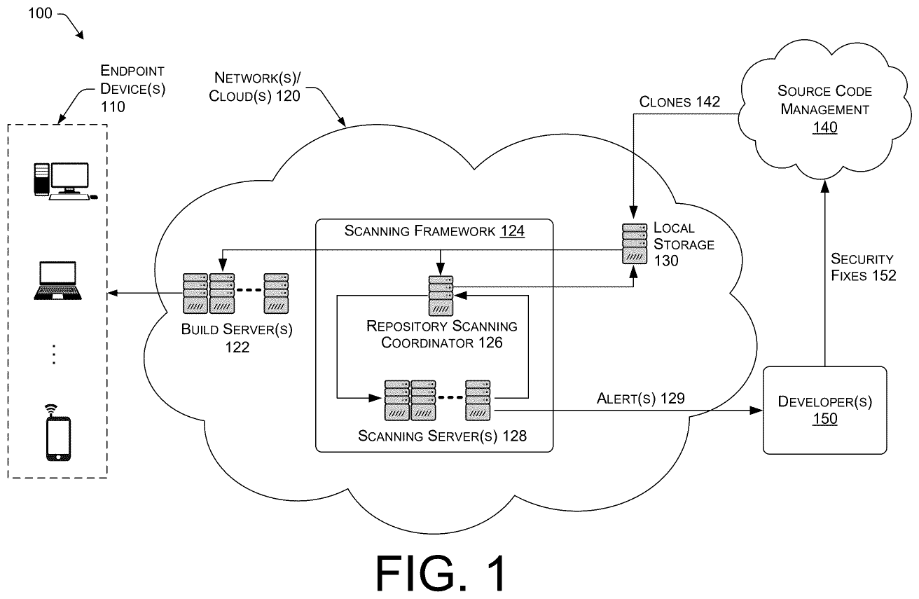

FIG. 1 illustrates an example network environment 100 comprising a scanning framework 124 equipped with a repository scanning coordinator 126, in accordance with an embodiment of the present disclosure. FIG. 1 comprises endpoint device(s) 110, network(s)/cloud(s) 120, source code management 140, and developer(s) 150. The network(s)/cloud(s) 120 includes the scanning framework 124 as well as build server(s) 122 and local storage 130. The scanning framework 124 comprises the repository scanning coordinator 126 and scanning server(s) 128.

The network(s)/cloud(s) 120 can further include any number of other components such as servers, virtual machines, application platforms, databases/storages, and security appliances, which are not illustrated in FIG. 1. In some embodiments, a security appliance can comprise a security agent which can be configured to provide a variety of security services for the network(s)/cloud(s) 120. The scanning framework 124 and/or the repository scanning coordinator 126 can optionally be configured as a component of a security agent in some implementations. Alternatively, the scanning framework 124 can be implemented at any devices in the network(s)/cloud(s) 120, such as at virtual machine(s), bare metal server(s), or Kubernetes style container system(s).

In some examples, the scanning framework 124 can be configured to provide a variety of security and static analysis services for a source codebase stored in source code management 140. For example, the scanning framework 124 can be configured to scan source code repositories associated with source code under development at the network(s)/cloud(s) 120. The scanning framework 124 can retrieve clone(s) 142 of source code repositories stored in source code management 140, and the scanning framework 124 can initiate operations of the repository scanning coordinator 126 and scanning server(s) 128, as described herein, to scan the source code repositories included in the clone(s) 142.

The scanning framework 124 can alert the developer(s) 150 of security issues identified by the scanning server(s) 128, e.g., by sending alert(s) 129 comprising data detected by the scanning servers 128 to the developer(s) 150 for analysis. The developer(s) 150 can optionally address the security issues by developing security fixes 152 and deploying the security fixes 152 to the source code at source code management 140. Furthermore, the developer(s) 150 may optionally send to the scanning framework 124 additional scanners, patterns, rules, etc., for use by the scanning server(s) 128 in connection with securing or monitoring the source codebase in source code management 140.

In a further aspect of FIG. 1, the one or more endpoint device(s) 110 can access, through a network, a variety of pre-built software located in the network(s)/cloud(s) 120. The one or more build server(s) 122 can be configured to provide software for devices in the network(s)/cloud(s) 120, for customers of the business that operates the network(s)/cloud(s) 120, and/or for the endpoint device(s) 110. The software may comprise, e.g., endpoint detection and response (EDR) tooling, log collection tooling, and/or any other software services.

The scanning framework 124 can comprise a variety of functions that facilitate security and analysis of source code stored in the source code management 140. In an example, the scanning framework 124 can be implemented as a collection of static code analysis tools to find source code vulnerabilities that may expose secret passphrases or other sensitive information. The network(s)/cloud(s) 120 can comprise a private network operated by a business, university, government agency or other entity.

In various examples, the endpoint device(s) 110 can comprise any devices that can connect to the networks/cloud(s) 120, either wirelessly or via direct cable connections. For example, the endpoint device(s) 110 may include but are not limited to mobile telephones, personal digital assistants (PDAs), media players, tablet computers, gaming devices, smart watches, hotspots, personal computers (PCs) such as laptops, desktops, or workstations, or any other type of computing or communication device. In other examples, the endpoint device(s) 110 may comprise vehicle-based devices, wearable devices, wearable materials, virtual reality (VR) devices, smart watches, smart glasses, clothes made of smart fabric, etc.

In various examples, the network(s)/cloud(s) 120 can be a public cloud, a private cloud, or a hybrid cloud and may host a variety of resources such as one or more local storage server(s) that provide local storage 130, one or more build server(s) 122, one or more scanning server(s) 128, one or more repository scanning coordinator server(s) that implement the repository scanning coordinator 126, etc. Server(s) may include pooled and centralized server resources related to application content, storage, and/or processing power. Virtual desktop(s) may image operating systems and applications of a physical device, e.g., any of endpoint device(s) 110, and allow users to access their desktops and applications from anywhere on any kind of endpoint devices.

Although shown as individual network participants in FIG. 1, the build server(s) 122, the local storage 130, the scanning server(s) 128, and the repository scanning coordinator 126 can be integrated and deployed on one or more computing devices and/or servers in the network(s)/cloud(s) 120.

In various examples, the scanning framework 124 can be deployed as one or more hardware-based appliances, software-based appliances, and/or cloud-based services. A hardware-based appliance may also be referred to as network-based appliance. The scanning framework 124 can act as a security mechanism between the source codebase in the source code management 140 and the endpoint device(s) 110 and can protect the software used in networks/cloud(s) 120 and endpoint device(s) 110 from being compromised by malicious actors.

FIG. 1 provides a wholistic view of the incorporation of a repository scanning coordinator 126 in a production system. Without the repository scanning coordinator 126, source code may be provided directly to build server(s) 122, which may in turn produce corresponding binary software and deliver it to customers. This poses a significant threat as bugs may be passed through to customer hosts, secrets may be leaked to the world, and critical security vulnerabilities may be introduced to customer machines.

The repository scanning coordinator 126 allows for the running of source code scanners on software under development, before such software is built at the build server(s) 122, thereby detecting security vulnerabilities before software is built and deployed. Regression testing, static code analysis, secret detection, and security scanning can optionally be achieved in parallel through the use of the repository scanning coordinator 126.

In an example according to FIG. 1, the repository scanning coordinator 126 can retrieve clone(s) 142 of remote source code from the source code management 140, and the clone(s) 142 can be stored in the local storage 130.

The repository scanning coordinator 126 can coordinate individual scanners operating at scanning server(s) 128 to scan the locally cloned source code. Rather than scanning the source code one scanner at a time in a pipeline, multiple scanners can be run concurrently and asynchronously as described herein. Furthermore, the source code can be monitored continuously or repetitively according to any desired interval, allowing for bug fixes, security patches, and purging of sensitive information in real time.

After being alerted of issues identified by scanners, developers 150 can develop and send security fixes 152 to the source code management 140. The security fixes 152 can address the issues identified by the scanning server(s) 128 and provided to the developer(s) 150 via alert(s) 129.

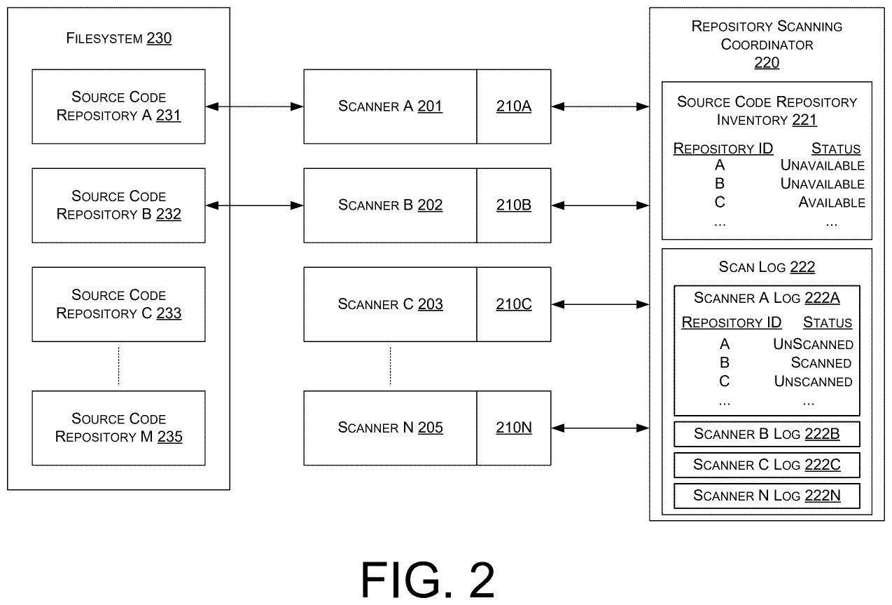

FIG. 2 illustrates an example repository scanning coordinator 220, scanners equipped to use the repository scanning coordinator 220, and a filesystem 230 comprising source code repositories 231, 232, 233, . . . , 235 to be scanned by the scanners, in accordance with an embodiment of the present disclosure. The example scanners include scanner A 201, scanner B 202, scanner C 203, . . . , and scanner N 205.

Each of the scanners 201-205 can comprise or can be supplemented with a coordinator interaction component which enables the scanner to interact with the repository scanning coordinator 220. Scanner A 201 is equipped with coordinator interaction component 210A, scanner B 202 is equipped with coordinator interaction component 210B, scanner C 203 is equipped with coordinator interaction component 210C, and scanner N 205 is equipped with coordinator interaction component 210N.

The example repository scanning coordinator 220 comprises a source code repository inventory 221 and a scan log 222. The source code repository inventory 221 can comprise a list of source code repositories to be scanned by the scanners 201-205. For example, the source code repository inventory 221 can include repository identifiers (IDs) for source code repositories A, B, C, . . . , etc.

The repository scanning coordinator 220 can maintain status data for each of the source code repositories listed in the source code repository inventory 221. For example, in FIG. 2, source code repositories A and B are listed as having an “unavailable” status, while source code repository C is listed as having an “available” status. The status information can indicate whether a source code repository is available for scanning by a scanner of scanners 201-205 and the repository scanning coordinator 220 can update the status information as described herein.

The repository scanning coordinator 220 can apply an “unavailable” status, also referred to herein as a “checked out” status, to a source code repository when a scanner has the source code repository checked out for scanning. The repository scanning coordinator 220 can apply an “available” status, also referred to herein as a “checked in” status, to a source code repository after the scanner has finished scanning the source code repository.

The scan log 222 can comprise log data for each of the scanners 201-205. For example, the scan log 222 can comprise a scanner A log 222A for scanner A 201, a scanner B log 222B for scanner B 202, a scanner C log 222C for scanner C 203, and a scanner N log 222N for scanner N 205. The scan log 222 can comprise data indicative of whether a scanner has performed a scan of a source code repository identified in the source code repository inventory 221. Thus for example, the scanner A log 222A can indicate the scanner A 201 has scanned source code repository B, but the scanner A 201 has not yet scanned source code repositories A and C. The repository scanning coordinator 220 can update the scan log 222 as the scanners complete scans of source code repositories.

In some embodiments, the information in the scan log 222 can indicate whether a scanner has checked out a source code repository, whether the scanner has checked in the source code repository, and additional data such as time of checkout and check in, branch scan data, etc. The scan log 222 can also store scan data on a per scanning run basis. For example, the repository scanning coordinator 220 can generate a first scan log 222 to store data associated with a first scan run of all applicable source code repositories by all scanners, a second scan log 222 to store data associated with a second scan run of all applicable source code repositories by all scanners, and so on.

In example operations according to FIG. 2, one or more setup operations can be performed in advance of repository scanning by the scanners 201-205. The repository scanning coordinator 220, or optionally another process such as a codebase enumeration service, can initially generate the source code repository inventory 221 based on one or more codebases. The repository scanning coordinator 220 can furthermore retrieve and store the source code repositories 231, 232, 233, . . . , 235 in the filesystem 230. The scanners 201-205 can be configured with the coordinator interaction components 210A, 210B, 210C, . . . , 210N, and the scanners 201-205 can be registered with the repository scanning coordinator 220.

Once the setup operations are complete, the repository scanning coordinator 220 can initiate scanning runs. Scanning runs can be initiated daily or on any desired interval, or scanning runs can otherwise be initiated irregularly or at any desired timing. Each scanning run can include coordinated scans of multiple, up to all, of the source code repositories 231, 232, 233, . . . , 235 by each of the scanners 201-205.

In a given scan run, the repository scanning coordinator 220 can receive application programming interface (API) requests from multiple scanners 201-205 to scan the source code repositories 231, 232, 233, . . . , 235. The repository scanning coordinator 220 can use the source code repository inventory 221 to process the API requests. Processing the API requests can enable parallel scanning of different source code repositories by the multiple scanners 201-205 by returning different identifications of the different source code repositories 231, 232, 233, . . . , 235 to the multiple scanners 201-205 in response to the API requests. Furthermore, processing the API requests can prevent simultaneous scanning of a single source code repository, e.g., single source code repository A, by the multiple scanners 201-205 by storing an indication that the single source code repository A is unavailable for scanning by other scanners of the multiple scanners 201-205 while the single source code repository A is being scanned by a single scanner, e.g., scanner A 201, of the multiple scanners 201-205.

In an example, the repository scanning coordinator 220 can coordinate parallel scan operations of multiple scanners 201-205 by performing a set of operations in response to each scan request in a series of scan requests from each of the scanners 201-205. Using scanner A 201 as an example, the repository scanning coordinator 220 can identify, in response to a scan request in a series of scan requests from scanner A 201, a next source code repository to be scanned by the scanner A 201. For example, the next source code repository could be source code repository B.

Identifying the next source code repository can comprise determining that the next source code repository has an availability status which is available for scanning, and that the scan log 222 shows the next source code repository has not already been scanned by scanner A 201. The repository scanning coordinator 220 can return to the scanner A 201 an identification of the next source code repository in order to enable scanning the next source code repository by the scanner A 201.

In some embodiments, identifying the next source code repository can further comprise performing filtering and/or exclusion of source code repositories, e.g., by reading one or more tags associated with the scanner A 201, and determining that the next source code repository meets a tag criterion specified in a tag which is associated with the scanner A 201. A tag can comprise any data structure which can hold or store data associated with a scanner. The repository scanning coordinator 220 can store tags associated with scanners, or each scanner can hold its own tags in a manner that is accessible by the repository scanning coordinator 220.

The repository scanning coordinator 220 can furthermore update an availability status of a previous source code repository scanned by the scanner A 201 to indicate the previous source code repository is available for scanning by other scanners. For example, if source code repository A was the previous source code repository scanned by the scanner A 201, the repository scanning coordinator 220 can update the availability status of source code repository A to indicate source code repository A is available for scanning by other scanners such as scanner B 202, scanner C 203, and scanner N 205.

The repository scanning coordinator 220 can furthermore update the availability status of the next source code repository (e.g., the source code repository B) to indicate the next source code repository is checked out by scanner A 201 and therefore unavailable for scanning by the other scanners such as scanner B 202, scanner C 203, and scanner N 205. The repository scanning coordinator 220 can also be configured to update the scan log 222 to indicate the previous source code repository (e.g., the source code repository A) was scanned by the scanner A 201.

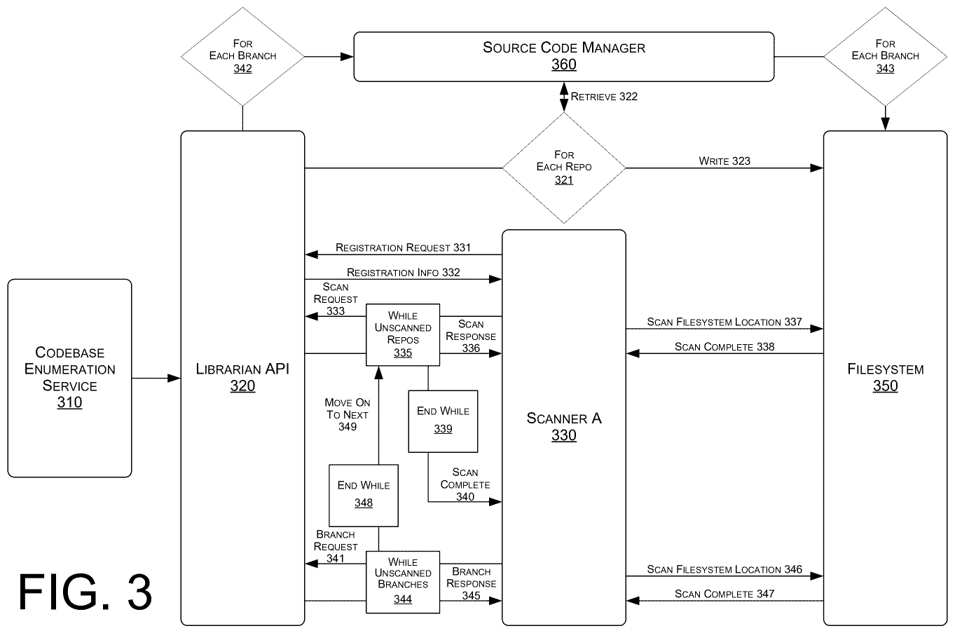

FIG. 3 illustrates an example repository scanning coordinator implementation and operations thereof, in accordance with an embodiment of the present disclosure. In FIG. 3, the repository scanning coordinator is implemented via a librarian API 320, in conjunction with the other illustrated elements. FIG. 3 comprises a codebase enumeration service 310, the librarian API 320, an example scanner A 330, a filesystem 350, and a source code manager 360. Furthermore, various example interactions between the illustrated elements are illustrated.

In an example according to FIG. 3, setup operations can include the codebase enumeration service 310 generating an inventory (also referred to herein as a library or list) of source code repositories for use by the librarian API 320. The librarian API 320 can retrieve the source code repositories from the source code manager 360 and the librarian API 320 can store the source code repositories in the filesystem 350. The librarian API 320 can furthermore register scanners, such as the example scanner A 330, to use the librarian API 320 when scanning the source code repositories in the filesystem 350.

After setup operations are complete, the librarian API 320 can coordinate scanning runs, whereby multiple scanners such as the example scanner A 330 scan the source code repositories in the filesystem 350 under coordination of the librarian API 320. Each scanner submits a series of API requests to the librarian API 320. Each of the API requests asks the librarian API 320 to identify a next source code repository in the filesystem 350. The librarian API 320 identifies next source code repositories for the scanners and performs checkout/check in operations to avoid scanner conflicts. The scanner that submitted an API request scans its identified next source code repository at a location in the filesystem 350 and the scanner can then return to the librarian API 320 for further source code repository identifications, until done.

Turning now to the operations illustrated in FIG. 3 in further detail, at 321, for each source code repository listed in an inventory at the librarian API 320, the librarian API 320 can retrieve 322 the source code repository from the source code manager 360, and the librarian API 320 can write 323 the source code repository to the filesystem 350. Retrieve 321 and write 323 can optionally be implemented via one or more GIT type interactions.

The librarian API 320 can be configured to register scanners, such as the example scanner A 330, by receiving and processing API requests from the scanners. For example, the scanner A 330 can submit a registration request 331 to the librarian API 320. The librarian API 320 can perform any desired security/authentication checks on the scanner A 330, and the librarian API 320 can assign a scanner identification (ID) number to the scanner A 330. The librarian API 320 can send registration information 332, e.g., the assigned scanner ID number, to the requesting scanner A 330. After source code repositories are stored in the filesystem 350 and scanners are registered, the librarian API 320 can initiate coordinated scanning runs.

In an example scanning run, each of the scanners can submit a series of scan requests. Operations of an example scanner A 330 are illustrated in FIG. 3. The scanner A 330 submits a scan request 333 to the librarian API 320. While there are remaining unscanned source code repositories 335 which have not been scanned by scanner A 330 (e.g., as reflected in log data maintained by the librarian API 320), the librarian API 320 can return a scan response 336 to the scanner A 330. The scan response 336 can identify a next source code repository to be scanned by the scanner A 330. In an example implementation, the scan response 336 can include a filesystem location of the next source code repository.

The scanner A 330 can scan the next source code repository identified in the scan response 336. For example, the scanner A 330 can scan the filesystem location 337 within the filesystem 350 which contains the next source code repository. The scan operation can complete at scan complete 338. The scanner A 330 can then submit another scan request 333 to identify a further source code repository for scanning.

When the librarian API 320 determines that the scanner A 330 has scanned all applicable source code repositories, the librarian API 320 can end while 339 by returning a scan complete 340 to the scanner A 330. The scanner A 330 can cease scanning operations until a next scan run.

For source code repositories comprising branches, the scanner A 330 can optionally submit branch requests to scan all available branches. The scanner A 330 submits an example branch request 341 to the librarian API 320. While unscanned branches 344 remain to be scanned by the scanner A 330, the librarian API 320 can request, for each branch 342, the branch source code repository from the source code manager 360, and the librarian API 320 can thereby cause, for each branch 343, the branch source code repository to be written to the filesystem 350. The librarian API 320 can then provide a branch response 345 to the scanner A 330, to notify the scanner A 330 of the branch filesystem location.

Upon receiving the branch response 345, the scanner A 330 can scan the branch source code repository at the identified filesystem location 346. The scan can complete at scan complete 347 and the scanner A 330 can submit a next branch request 341. When no further branches remain, the librarian API 320 can end while 348 and the process can move on to a next source code repository 349, or to end while 339, as applicable.

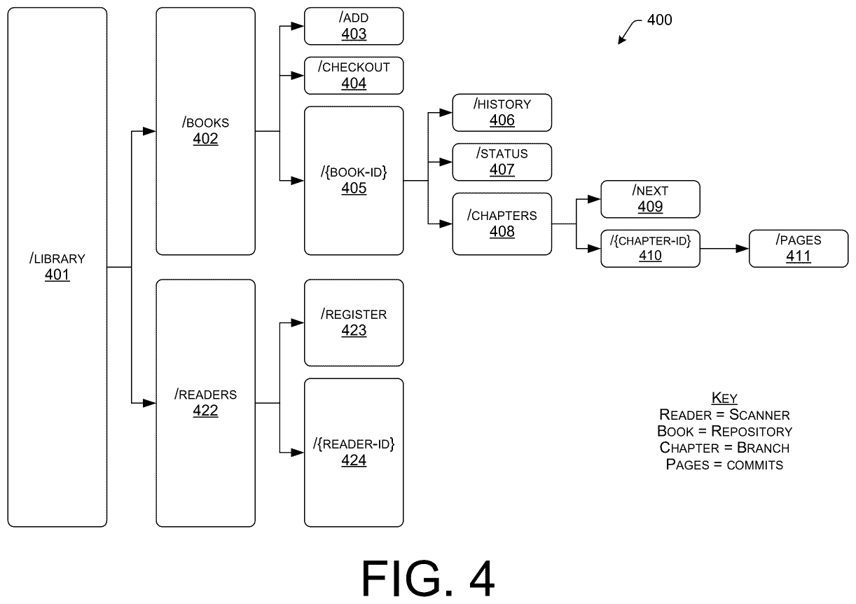

FIG. 4 illustrates an example layout of a librarian application programming interface (API), in accordance with an embodiment of the present disclosure. The illustrated librarian API 400 may comprise a “restful” type API. A key in FIG. 4 maps book library terminology to source code scanning terminology. A reader refers to a scanner, a book is a source code repository, a chapter is a branch of a source code repository, and pages are commits.

The librarian API 400 can be organized under /Library 401. A request to the librarian API 400 for /Library/Books 402 can return a list of books (i.e., a list of source code repositories). A request to the librarian API 400 for /Library/Books/Add 403 can add a book (i.e., a source code repository). A request to the librarian API 400 for /Library/Books/Checkout 404 can return a book (i.e., a source code repository) not already read by a scanner.

A request to the librarian API 400 for /Library/Books/{Book-ID}405 can return metadata about a book (i.e., a source code repository). A request to the librarian API 400 for /Library/Books/{Book-ID}/History 406 can return a history of who has already read the book (i.e., which scanners have scanned a source code repository). A request to the librarian API 400 for /Library/Books/{Book-ID}/Status 407 can return a book status (i.e., whether a source code repository is checked in and available or checked out and unavailable). A request to the librarian API 400 for /Library/Books/{Book-ID}/Chapters 408 can return a list of all chapters in a book (i.e., branches of a source code repository).

A request to the librarian API 400 for /Library/Books/{Book-ID}/Chapters/Next 409 can return a next unread chapter (i.e., a next unread branch source code repository not read by the scanner). A request to the librarian API 400 for /Library/Books/{Book-ID}/Chapters/{Chapter-ID}410 can return metadata about a chapter (i.e., a source code repository branch). A request to the librarian API 400 for /Library/Books/{Book-ID}/Chapters/{Chapter-ID}/Pages 411 can return a list of all commits in a chapter (i.e., a list of all commits in a source code repository branch).

A request to the librarian API 400 for /Library/Readers 422 can return a list of all registered readers (i.e., scanners). A request to the librarian API 400 for /Library/Readers/Register 423 can register a new reader (i.e., a new scanner). A request to the librarian API 400 for /Library/Readers/{Reader-ID}424 can return metadata about a reader (i.e., a scanner), such as whether a book is checked out by the scanner, what book is checked out by the scanner, and whether all books have been read/scanned by the scanner.

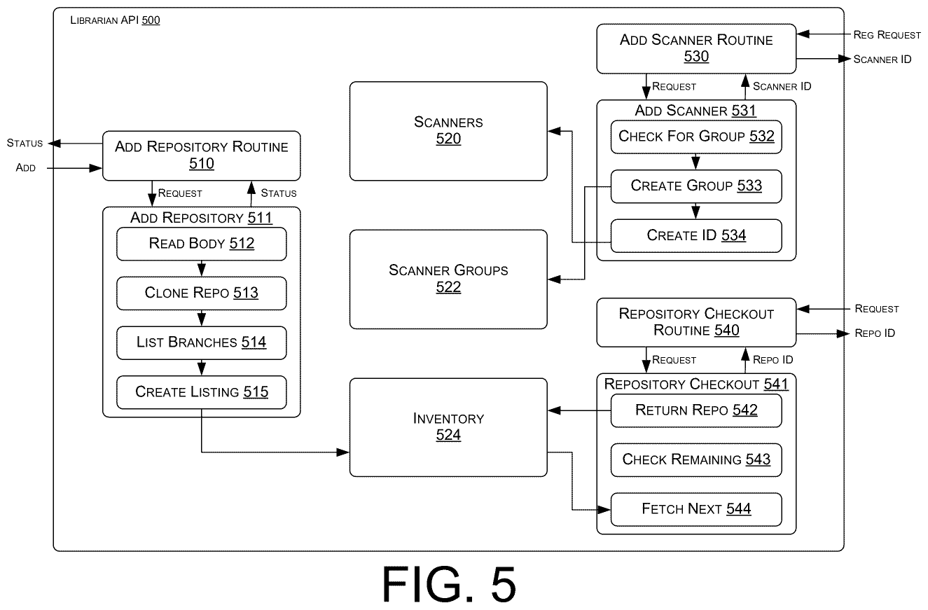

FIG. 5 illustrates example internal workflows and data structures used by a librarian API, in accordance with an embodiment of the present disclosure. The example librarian API 500 can implement the librarian API 320 or the repository scanning coordinator 220 in some embodiments. The librarian API 500 comprises a workflow for adding a new source code repository at left under add repository routine 510, a workflow for adding a new scanner at right under add scanner routine 530, and a workflow for source code repository checkout at right under repository checkout routine 540. The add repository routine 510, add scanner routine 530, and repository checkout routine 540 can all be implemented as goroutines in some embodiments. The librarian API 500 further comprises scanners 520, scanner groups 522, and inventory 524.

The add repository routine 510 can be initiated by an add request, causing the add repository routine 510 to submit a request to add repository 511. Add repository 511 can read a body of the new source code repository at 512, clone the new source code repository at 513, e.g., from a remote URL to a local filesystem, list the new source code repository's remote branches at 514, and create a repository listing in the inventory 524 at 515. When done, add repository 511 can return a done status to add repository routine 510, which can report the done status to the requesting entity.

The add scanner routine 530 can be initiated by a registration request, causing the add scanner routine 530 to submit a request to add scanner 531. Add scanner 531 can check scanner groups 522 at check for group 532 to determine if a scanner group exists for the new scanner. If not, a new scanner group can be created among the scanner groups 522 at create group 533. An ID for the new scanner can created at 534 and the new scanner ID can be inserted among scanners 520. When done, add scanner 531 can return a scanner ID to add scanner routine 530, which can report the scanner ID to the requesting entity.

The repository checkout routine 540 can be initiated by a request, e.g., a scan request, causing the repository checkout routine 540 to request a repository checkout 541. Repository checkout 541 can return or check in a previously scanned repository at 542, e.g., by setting a checkout state to “false” in the inventory 524. Repository checkout 541 can look for any remaining source code repositories at 543, e.g., by checking a log associated with the requesting scanner. If none, the repository checkout 541 can return a none message to the repository checkout routine 540.

If source code repositories remain to be scanned, then repository checkout 541 can fetch a next source code repository 544 from the inventory 524. The repository checkout 541 can select any available source code repository from the inventory 524 which has not yet been scanned by the scanner. The repository checkout 541 can set a checkout state to “true” in the inventory 524. When done, repository checkout 541 can return a repository ID (e.g., a filesystem location) of the next source code repository to repository checkout routine 540, which can report the repository ID to the requesting scanner.

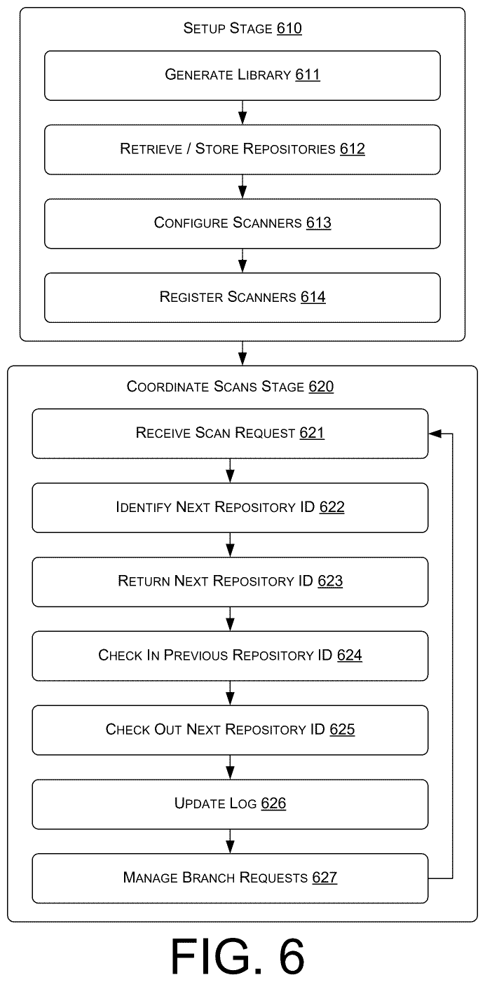

FIG. 6 illustrates example methods performed by a repository scanning coordinator, including a setup stage and a coordinate scans stage, in accordance with an embodiment of the present disclosure. By way of example and without limitation, the methods are illustrated in FIG. 6 as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined (or omitted) in any order and/or in parallel to implement the processes. In some examples, multiple branches represent alternate implementations that may be used separately or in combination with other operations discussed herein.

The operations illustrated in FIG. 6 can be performed at least in part by a repository scanning coordinator 220 such as illustrated in FIG. 2. In general, methods according to FIG. 6 can be used to coordinate parallel scan operations of multiple scanners. The multiple scanners can include multiple different scanners and/or instances of a same scanner. Spawning multiple instances of a same scanner and enabling the multiple instances to scan different source code repositories can optionally be performed to speed the scanning completion time.

The setup stage 610 can comprise operations 611, 612, 613, and 614. At operation 611, the repository scanning coordinator 220 or a supplemental service such as the codebase enumeration service 311 can generate a library of source code repositories. For example, the repository scanning coordinator 220 can generate the source code repository inventor 221, which comprises a list of source code repositories to be scanned.

At operation 612, the repository scanning coordinator 220 can retrieve and store multiple source code repositories, e.g., the source code repositories 231, 232, 233, . . . , 235 in a filesystem 230. Retrieving the source code repositories 231, 232, 233, . . . , 235 can comprise performing global information tracker (GIT) interactions to fetch the source code repositories 231, 232, 233, . . . , 235. The repository scanning coordinator 220 can furthermore handle any authentication or other security operations as needed. For example, the repository scanning coordinator 220 can retrieve and store source code repositories from a source code manager 360 such as illustrated in FIG. 3.

At operation 613, the repository scanning coordinator 220, or another supplemental process or tool can be used to configure multiple scanners 201-205 to communicate with an application programming interface (API) supported by the repository scanning coordinator 220. For example, multiple scanners 201-205 can each be “wrapped” or otherwise provided with an interaction component 210A, 210B, 210C, . . . , 210N, which enables the multiple scanners 201-205 to communicate with the repository scanning coordinator 220.

At operation 614, the repository scanning coordinator 220 can register the multiple scanners 201-205. Each of the multiple scanners 201-205 can submit a registration request to register itself among the multiple scanners to be coordinated by the repository scanning coordinator 220. The registration requests can optionally be submitted by or via the interaction components 210A, 210B, 210C, . . . , 210N. The repository scanning coordinator 220 can receive the registration requests and can register the new scanners in response thereto. The repository scanning coordinator 220 can return registration information, such as scanner IDs, to the multiple scanners 201-205.

Operations of the setup stage 610 can optionally be repeated as needed, e.g., to update the library/inventory of source code repositories, update the filesystem, configure new scanners, and/or register new scanners. Once the setup stage 610 is complete, the repository scanning coordinator 220 can coordinate scanning runs according to the coordinate scans stage 620.

The coordinate scans stage 620 can comprise example operations 621, 622, 623, 624, 625, 626, and 627. The operations 621, 622, 623, 624, 625, 626, and 627 can be performed for each scanner of the multiple scanners 201-205 coordinated by the repository scanning coordinator 220, and the operations can be repeated for each of multiple scan requests in a series of scan requests from each scanner, as needed until the scanner is done scanning all applicable source code repositories of the source code repositories 231, 232, 233, . . . , 235. The operations 621, 622, 623, 624, 625, 626, and 627 will be discussed below in the context of a scan request from example scanner A 201, understanding that the operations are repeated for other can scan requests from example scanner A 201 and the operations 621, 622, 623, 624, 625, 626 are also performed for the other scanners such as scanner B 202, scanner C 203, and scanner N 205.

At operation 621, the repository scanning coordinator 220 can receive a scan request from scanner A 201. For example, the repository scanning coordinator 220 can receive an API call which includes a scan request. At operation 622, the repository scanning coordinator 220 can identify, in response to the scan request in the series of scan requests, a next source code repository, e.g., source code repository A, to be scanned by the scanner A 201. The next source code repository can be identified from a library of source code repositories such as the source code repository inventory 221. Identifying the next source code repository can comprise determining that the next source code repository has an availability status which is available for scanning. Furthermore, identifying the next source code repository can comprise checking the scanner A log 222A to determine that the next source code repository is unscanned by the scanner A 201.

In some embodiments, identifying the next source code repository can comprise performing filtering and/or exclusion of source code repositories, e.g., by reading one or more tags associated with a scanner, and determining that the next source code repository meets a tag criterion specified in a tag which is associated with the scanner. For example, scanners may be configured to scan a subset of the source code repositories 231, 232, 233, . . . , 235, and the subset definition can be included in a tag. Tags may also exclude certain source code repositories or otherwise define applicable source code repositories, and tag criteria can be applied by the repository scanning coordinator 220.

At operation 623, the repository scanning coordinator 220 can return a next repository ID to the requesting scanner A 201 to enable scanning the next source code repository by the scanner A 201. The repository ID can include any desired ID information which enables the scanner A 201 to find the next source code repository in the filesystem 230. For example, the repository ID can include a location such as a file path which locates the next source code repository in the filesystem 230.

At operation 624, the repository scanning coordinator 220 can “check in” a previous source code repository scanned by the scanner A 201. For example, when the previous source code repository was source code repository B, the repository scanning coordinator 220 can update an availability status of source code repository B to indicate source code repository B is available for scanning by other scanners such as scanner B 202, scanner C 203, and scanner N 205.

At operation 625, the repository scanning coordinator 220 can “check out” the next source code repository to be scanned by the scanner A 201. For example, when the next source code repository is source code repository A, the repository scanning coordinator 220 can update an availability status of code repository A to indicate source code repository A is unavailable for scanning by other scanners such as scanner B 202, scanner C 203, and scanner N 205.

At operation 626, the repository scanning coordinator 220 can update a log, e.g., scanner A log 222A, to indicate the previous source code repository (in this example, source code repository B) was scanned by the scanner A 201.

At operation 627, for repositories including multiple branches, methods according to FIG. 6 can further comprise managing branch requests from a scanner while the scanner has a source code repository checked out. For example, the repository scanning coordinator 220 can receive a repository branch scan request for a repository branch scan to be performed by the scanner A 201. In response to the repository branch scan request, the repository scanning coordinator 220 can retrieve and store a repository branch in the filesystem 230. The repository scanning coordinator 220 can notify the scanner A 201 of the branch in the filesystem 230, enabling the scanner A 201 to scan the branch and return with further branch scan requests until all applicable branches are scanned.

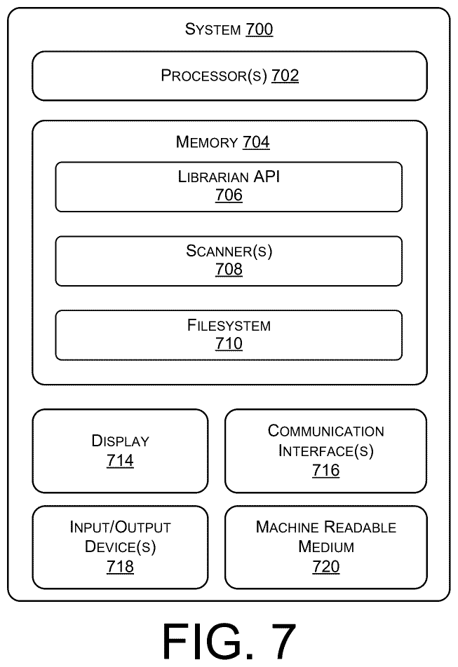

FIG. 7 illustrates an example system equipped to perform the techniques described herein, in accordance with an embodiment of the present disclosure. The example system 700 can be implemented as one or more computing devices. As illustrated in FIG. 7, a system 700 may comprise processor(s) 702, a display 714, communication interface(s) 716, input/output device(s) 718, and/or a machine readable medium 720. Furthermore, the system 700 can comprise a memory 704 storing a librarian API 706, scanner(s) 708, and a filesystem 710.

In various examples, the processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 702 may also be responsible for executing all computer applications stored in memory 704, which can be associated with common types of volatile (RAM) and/or nonvolatile (ROM) memory.

In various examples, the memory 704 can include system memory, which may be volatile (such as RAM), non-volatile (such as ROM, flash memory, etc.) or some combination of the two. The memory 704 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the system 700. Any such non-transitory computer-readable media may be part of the system 700.

The memory 704 can include module(s) which, when executed, cause the processor(s) 702 to perform actions described herein. The librarian API 706, scanner(s) 708, and filesystem 710 can comprise modules that cause the processor(s) 702 to perform functions of corresponding components illustrated and described in FIGS. 1-6.

Display 714 can be a liquid crystal display or any other type of display commonly used in the system 700. For example, display 714 may be a touch-sensitive display screen and can then also act as an input device or keypad, such as for providing a soft-key keyboard, navigation buttons, or any other type of input. Input/output device(s) 718 can include any sort of output devices known in the art, such as display 714, speakers, a vibrating mechanism, and/or a tactile feedback mechanism. Input/output device(s) 718 can also include ports for one or more peripheral devices, such as headphones, peripheral speakers, and/or a peripheral display. Input/output device(s) 718 can include any sort of input devices known in the art. For example, input/output device(s) 718 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The communication interface(s) 716 can include transceivers, modems, interfaces, antennas, and/or other components that perform or assist in exchanging radio frequency (RF) communications with base stations of the telecommunication network, a Wi-Fi access point, and/or otherwise implement connections with one or more networks.

The machine readable medium 720 can store one or more sets of instructions, such as software or firmware, that embodies any one or more of the methodologies or functions described herein. The instructions can also reside, completely or at least partially, within the memory 704, processor(s) 702, and/or communication interface(s) 716 during execution thereof by the system 700. The memory 704 and the processor(s) 702 also can constitute machine readable media 720.

The various techniques described herein may be implemented in the context of computer-executable instructions or software, such as program components, that are stored in computer-readable storage and executed by the processor(s) of one or more computing devices such as those illustrated in the figures. Generally, program components include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method to coordinate parallel scan operations of multiple scanners, comprising:
for a scanner of the multiple scanners:
receiving a series of scan requests for scans to be performed by the scanner;
in response to a scan request in the series of scan requests, enabling a next source code repository to be scanned by the scanner, wherein the next source code repository has an availability status indicating the next source code repository is available for scanning;
updating an availability status of a previous source code repository scanned by the scanner to indicate the previous source code repository is available for scanning by other scanners; and
updating the availability status of the next source code repository to indicate the next source code repository is unavailable for scanning by the other scanners.

2. The method of claim 1, further comprising updating a log to indicate the previous source code repository was scanned by the scanner, and wherein identifying the next source code repository to be scanned by the scanner further comprises determining that the next source code repository is unscanned by the scanner.

3. The method of claim 1, wherein the method is performed via an application programming interface configured to receive the series of scan requests.

4. The method of claim 3, further comprising configuring at least one of the multiple scanners to communicate with the application programming interface.

5. The method of claim 1, further comprising retrieving and storing multiple source code repositories in a filesystem, the multiple source code repositories including the previous source code repository and the next source code repository, and wherein the identification of the next source code repository returned to the scanner comprises a location of the next source code repository in the filesystem.

6. The method of claim 5, wherein retrieving the multiple source code repositories comprises one or more global information tracker (GIT) interactions to fetch the multiple source code repositories.

7. The method of claim 1, wherein the enabling the next source code repository to be scanned by the scanner comprises identifying the next source code repository from a library of source code repositories, and the method further comprising generating the library of source code repositories.

8. The method of claim 1, further comprising:
receiving a repository branch scan request for a repository branch scan to be performed by the scanner; and
retrieving and storing a repository branch in a filesystem in response to the repository branch scan request.

9. The method of claim 1, wherein the multiple scanners include multiple instances of a same scanner.

10. The method of claim 1, wherein identifying, in response to the scan request, the next source code repository to be scanned by the scanner further comprises determining that the next source code repository meets a tag criterion specified in a tag associated with the scanner.

11. The method of claim 1, further comprising:
receiving a registration request to register a new scanner among the multiple scanners; and
registering the new scanner in response to the registration request.

12. A system, comprising:
a processor, and
at least one memory storing instructions executed by the processor to perform actions to enable parallel scan operations of multiple scanners, the actions including:
registering multiple scanners to enable the multiple scanners to perform scans of multiple source code repositories;
retrieving and storing the multiple source code repositories in a filesystem;
generating a library comprising identifications of the multiple source code repositories; and
using the library to process application programming interface requests from the multiple scanners to scan source code repositories of the multiple source code repositories stored in the filesystem, wherein processing the application programming interface requests enables parallel scanning of different source code repositories by the multiple scanners, and wherein processing the application programming interface requests prevents simultaneous scanning of a single source code repository by the multiple scanners.

13. The system of claim 12, wherein processing the application programming interface requests enables parallel scanning of different source code repositories by the multiple scanners by returning different identifications of the different source code repositories to the multiple scanners in response to the application programming interface requests.

14. The system of claim 12, wherein processing the application programming interface requests prevents simultaneous scanning of the single source code repository by the multiple scanners by storing an indication that the single source code repository is unavailable for scanning by other scanners of the multiple scanners while the single source code repository is being scanned by a single scanner of the multiple scanners.

15. The system of claim 12, wherein the actions further include maintaining a log to indicate which of the multiple source code repositories have been scanned by scanners of the multiple scanners.

16. The system of claim 12, wherein the actions further include using the library to process application programming interface requests from the multiple scanners to repository branches associated with the multiple source code repositories stored in the filesystem.

17. A computer-readable storage medium storing computer-readable instructions, that when executed by a processor, cause the processor to perform actions comprising:
receiving application programming interface requests from multiple scanners to scan source code repositories; and
using a library comprising identifications of the source code repositories to process the application programming interface requests,
wherein processing the application programming interface requests enables parallel scanning of different source code repositories by the multiple scanners by returning different identifications of the different source code repositories to the multiple scanners in response to the application programming interface requests, and
wherein processing the application programming interface requests prevents simultaneous scanning of a single source code repository by the multiple scanners by storing an indication that the single source code repository is unavailable for scanning by other scanners of the multiple scanners while the single source code repository is being scanned by a single scanner of the multiple scanners.

18. The computer-readable storage medium of claim 17, wherein the actions further comprise performing codebase enumeration to generate the library.

19. The computer-readable storage medium of claim 17, wherein the source code repositories are stored in a filesystem accessible by the multiple scanners, and wherein using the library comprising to process the application programming interface requests comprises returning filesystem locations of source code repositories to the multiple scanners.

20. The computer-readable storage medium of claim 17, wherein the actions further comprise registering the multiple scanners to enable the multiple scanners to perform scans of the source code repositories.
